(19) United States
(12) Patent Application Publication
(10) Pub. No.: US 2003/0065586 A1
(43) Pub. Date: Apr. 3, 2003

(54) Electronic commerce product pricing and selection system and method

(76) Inventors: Keith L. Shaftel, Houston, TX (US); Jeffrey R. Whatcott, Acton, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/919,420

(22) Filed: Jul. 31, 2001

(51) Int. Cl. G06F 17/60

(52) U.S. Cl. 705/27

(57) ABSTRACT

An electronic commerce product pricing and selection system and method is disclosed. A product cost and a product attribute corresponding to a product are first received from a vendor via a communications network. A sale price is then determined for the product using the product cost and a competitive price is determined using the product attribute. The sale price and the competitive price are then compared and the product is displayed for sale on a website at the sale price if the sale price is determined to be within a predefined range or threshold of the competitive price.

### FIELD OF THE INVENTION

The field of the invention relates generally to computer networking and software, electronic commerce systems, and product pricing systems. More particularly, the field of the invention relates to an electronic commerce product pricing and selection system and method.

### BACKGROUND

Computer networks such as the Internet and the World Wide Web (WWW) have developed into a convenient medium by which businesses and consumers can sell and purchase goods and services. To facilitate such commercial activity or “electronic commerce”, businesses provide virtual stores electronically utilizing web, application, and transaction servers which a customer can then access using a web browser client application. Conventional online stores include back-office systems, including billing, order fulfillment, and security systems which encrypt transactions and prevent access to other components of the electronic commerce system, as well as applications which track inventory to produce up-to-date catalogs of a business's available goods. Electronic orders are received using electronic storefront web pages or websites displaying a store's catalog. Once received, orders can be processed, the store's inventory database and catalog may be updated, and the customer can be billed automatically using various components of the online store's back-office system with the entire transaction taking place online.

Today, businesses offer an extremely wide variety of products online. Electronic commerce storefronts may feature products in their owner/host's own inventory or products belonging to the inventory of an independent vendor or supplier, generating revenue in the form of advertising fees, retail “markups”, or commissions from the transactions they facilitate. Many businesses have attempted to offer the products of others via this “virtual” inventory mechanism in order to present a greater variety of products or a wider selection of a particular product to consumers or to avoid having to invest their own capital in inventory, particularly if a product's acquisition cost is high and/or if the average amount of time between product acquisition and product sale is long. Until recently, true virtual inventory electronic commerce systems have been extremely difficult to implement, requiring e-commerce businesses to integrate and maintain vendor and product selection, access to vendor inventory information, and product quality and pricing supervision in a single electronic commerce website. While recently developed e-commerce systems have overcome many obstacles associated with providing access to vendor inventory information, they have yet to address product pricing supervision or the selection of vendors or products based on product price or margin which has made the adaptation of some products to the virtual inventory model even more difficult. Gemstones, such as diamonds, are an example of a product which has been particularly difficult to adapt to virtual inventory e-commerce systems due to this shortcoming.

Gemstones are typically a personal, expensive, and infrequent consumer purchase and consequently an attractive product to sell via a virtual inventory mechanism. Consumers desire large inventories, competitive prices, and the assurance of product quality and the absence of fraud when selecting gemstones or jewelry for purchase. Virtual inventory systems would allow gemstone e-tailers to offer a wider selection of stones without having to undertake the typically high acquisition costs and often long product cycles associated with gems or jewelry. Such virtual inventory systems would likewise allow consumers to make a greater variety of purchases at fewer electronic stores in which they have confidence. Conventional gemstone pricing methods have, until recently however, prevented gemstones or related jewelry products from being integrated into a true virtual inventory electronic commerce system.

Diamonds as one example, have been traditionally priced according to several well-known characteristics, some of which are inherent to the stone itself (clarity, color, fluorescence) and some of which are given to the stone as it is processed or “cut” (shape, weight, lab certification, and cut, finish, or “make”). A diamond is typically first assigned an initial wholesale or “market” price using a price index based solely upon the shape, weight, color and clarity of a stone. This wholesale price is theoretically indicative of jeweler/retailer cost or per-carat diamond price between mining or cutting institutions and diamond retail shops. The wholesale price is then modified based on some or all of the remaining characteristics. Although there are widely accepted standards for many diamond characteristics there is broad disagreement about others and no objective standard of how each should impact the final asking or sale price of a stone. Consequently, diamonds have been priced almost exclusively on an individual basis, requiring that a highly trained gemologist physically handle and inspect each stone to determine an appropriate price based on the stone's characteristics and appearance. This requires many gemologists to price a large number of stones and often results in inconsistencies or inaccuracies in price due to human error or the subjective nature of the process itself.

As a result of the above-described shortcomings of traditional pricing mechanisms for products such as diamonds, many electronic commerce businesses have been unable to provide the improved pricing, selection, and product information associated with virtual inventory systems.

### SUMMARY OF THE INVENTION

The present invention is an electronic commerce product pricing and selection system and method. A product cost and a product attribute corresponding to a product are first received from a vendor via a communications network. A sale price is then determined for the product using the product cost and a competitive price is determined using the product attribute. The sale price and the competitive price are then compared and the product is displayed for sale on a website at the sale price if the sale price is determined to be within a predefined range or threshold of the competitive price.

### BRIEF DESCRIPTION OF THE DRAWINGS

The present invention is illustrated by way of example and not limitation in the figures of the accompanying drawings, in which:

FIG. 1a illustrates a conventional data processing system useable with the present invention;

FIG. 1b illustrates a high-level block diagram of the data processing system depicted in FIG. 1a;

FIG. 2 illustrates a system diagram of a communications network of the present invention;

FIG. 3 illustrates a high-level flow diagram of the operation of retailer server 202 of FIG. 2;

FIG. 4 illustrates a high-level logic flowchart of one embodiment of the method of the present invention; and

FIG. 5 illustrates web browser consumer client display output according to one embodiment of the present invention.

### DETAILED DESCRIPTION

An electronic commerce product pricing and selection system and method is disclosed. In the following detailed description, numerous specific details are set forth in order to provide a thorough understanding of the present invention. However, it will be apparent to one of ordinary skill in the art that these specific details need not be used to practice the present invention. In other circumstances, well-known structures, materials, circuits, processes and interfaces have not been shown or described in detail in order not to unnecessarily obscure the present invention.

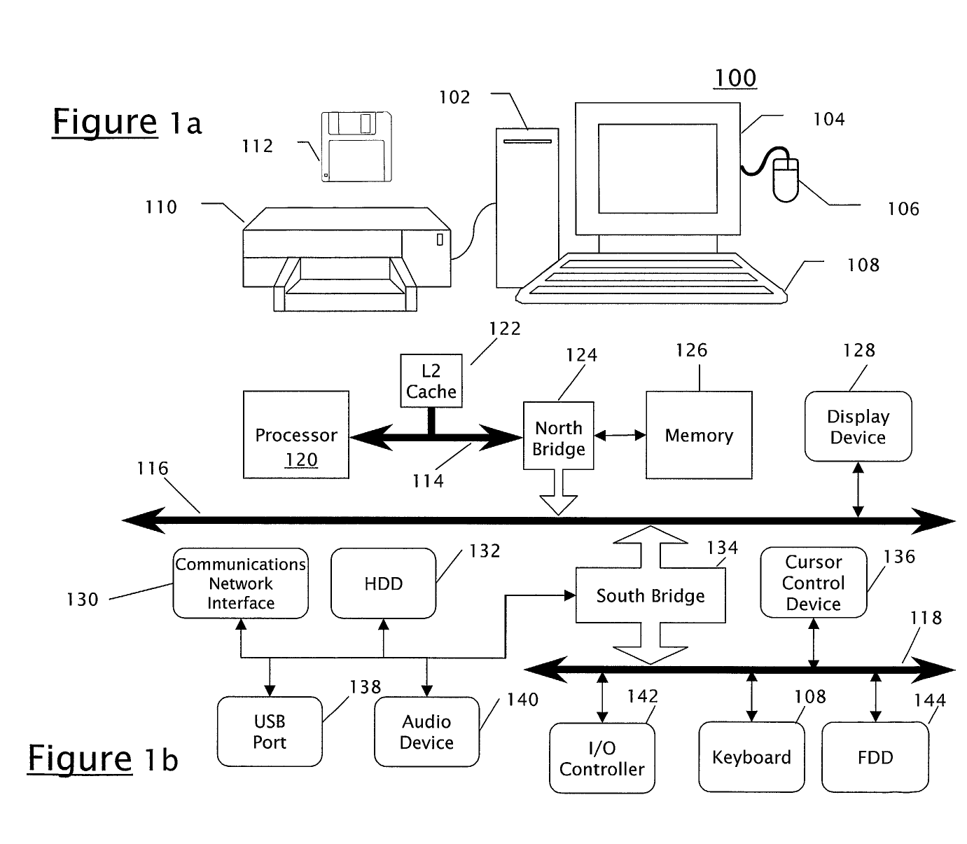

Referring now to FIG. 1a, a conventional data processing system 100 useable with the present invention is illustrated. Data processing or computer system 100 is comprised of a system unit 102, output devices such as display 104 and printer 110, and input devices such as keyboard 108, and mouse 106. Data processing system 100 receives data for processing by the manipulation of input devices 108 and 106 or directly from fixed or removable media storage devices such as disk 112 and network connection interfaces (not shown). Data processing system 100 then processes data and presents resulting output data via output devices such as display 104, printer 110, fixed or removable media storage devices like disk 112 or network connection interfaces.

Referring now to FIG. 1b, there is depicted a high-level block diagram of the components of a data processing system 100 such as that illustrated by FIG. 1a. In a conventional computer system, system unit 102 includes a processing device such as processor 120 connected to a level two (L2) cache 122 over a processor system bus (PSB) 114. Processor system bus 114 is in turn coupled to an expansion bus such as local bus 116 and a memory 126 via a north bridge circuit 124. Local bus 116 may include a peripheral component interconnect (PCI), Video Electronics Standards Association (VESA) bus or the like, tightly coupled to the processor 120 and the processor system bus 114 to permit high-speed access to select devices such as display device 128.

Memory 126 may include read-only (ROM) and/or random access (RAM) memory devices such as a synchronous dynamic random access memory (SDRAM) module capable of storing data as well as instructions to be executed by processor 120. Access to data and instructions stored within memory 126 is provided via a memory controller (not shown) within north bridge circuit 124. L2 cache 122 is similarly used, typically in a hierarchical manner, to store data and instructions for direct access by processor 120. Display device 128 may include a cathode ray tube (CRT) display such as display 104, a liquid crystal display (LCD), or a similar device for displaying various kinds of data to a computer user. For example, image, textual or other graphical information may be presented to the user on display device 128. System unit 102 of data processing system 100 also features an expansion or “compatibility” bus 118 such as the Industry Standard Architecture (ISA) bus, and a south bridge circuit 134 coupling it to local bus 116 to facilitate the attachment of other, relatively slower devices to the system 100. South bridge circuit 134 includes a universal serial bus (USB) port 138 as well as other direct connections for devices like a communications network interface 130 such as a network interface card (NIC) or modem, a data storage device, such as a magnetic hard disk drive 132, and an audio device 140 such as a speaker or sound card. Thus, a machine-readable medium includes any mechanism that provides (i.e., stores and/or transmits) information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

Other devices not directly coupled to south bridge 134 may be connected to the system 100 via the expansion bus 118 as illustrated. A floppy disk drive (FDD) 144 providing additional data storage capacity on removable media storage devices such as disk 112, and input devices such as a keyboard 108 and a cursor control device 136 are each coupled to expansion bus 118 in this manner to communicate data, instructions, and/or command selections to processor 120. Cursor control device 136 may comprise a conventional mouse such as mouse 106 of FIG. 1a, a trackball, or any other device capable of conveying desired cursor manipulation. Similarly, expansion bus 118 includes an input/output (I/O) controller having standard serial and parallel port functionality for connecting other I/O devices such as printer 110 to the system.

The system of the present invention includes software, information processing hardware, and various processing steps, which will be described below. The features and process operations of the present invention may be embodied in executable instructions stored within a machine-readable medium such as disk 112. The instructions can be used to cause a general purpose or special purpose processor such as processor 120, which is programmed with the instructions to perform the described methods of the present invention. Alternatively, the features or steps of the present invention may be performed by specific hardware components that contain hard-wired logic for performing the steps, or by any combination of programmed computer components and custom hardware components.

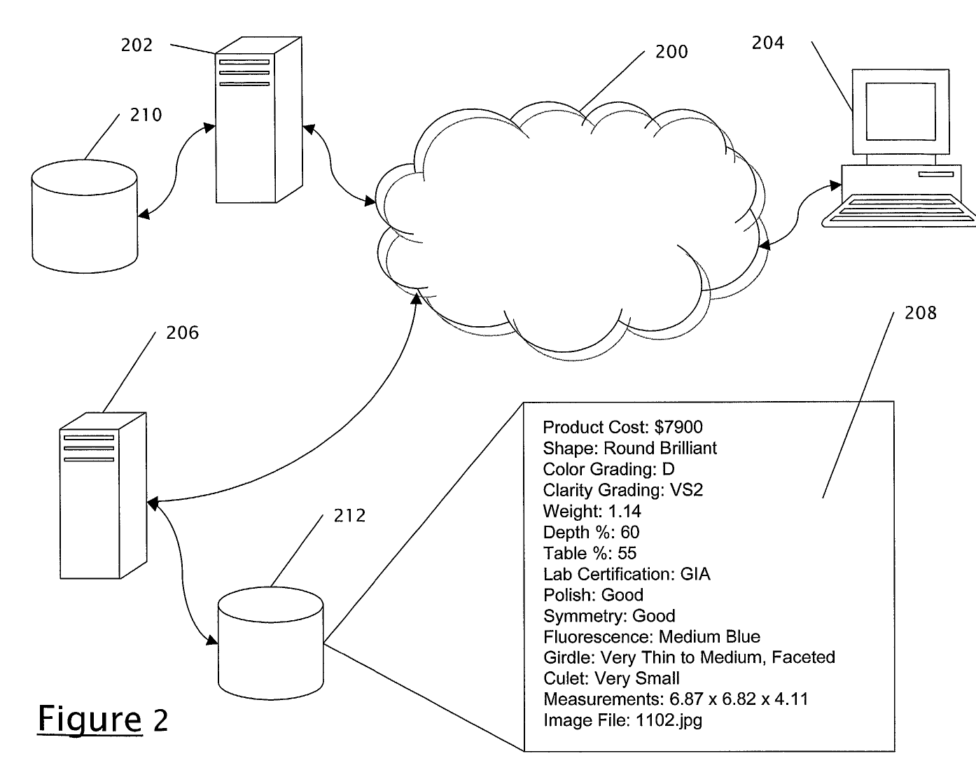

Referring now to FIG. 2, a system diagram of a communications network according to one embodiment of the present invention is illustrated. In the illustrated embodiment, a retailer server 202, a consumer client 204, and a vendor server 206 are each coupled to a communications network 200. In the illustrated embodiment, communications network 200 comprises a wide area network (WAN) such as the Internet or a proprietary network such as America Online™, Prodigy™, etc. potentially including conventional network backbones, long-haul telephone lines, Internet service providers, various levels of network routers, as well as other conventional means for routing data between data processing systems or similar devices. In alternative embodiments of the present invention the communications network may be implemented on a comparatively smaller geographic scale such as a local area network (LAN). In embodiments where WAN 200 comprises a public network such as the Internet, data such as product information 208 may be transmitted with or without encryption or may alternatively be transmitted via a restricted access network such as a virtual private network (VPN), intranet, or a partially private extranet.

As illustrated, product information 208 can include a wide variety of data such as the vendor's asking price or product cost, the shape, color, clarity, weight, fluorescence, polish, symmetry, and the lab certifications of an available stone, image files such as a Joint Photographic Experts Group (JPEG) file containing images of the stone as well as various stone cut characteristics such as depth and table percentages, length-to-width ratios, girdle and culet descriptions, and the stone's overall dimensions. In alternative embodiments of the present invention greater or fewer gemstone characteristics such as these may be utilized. In such embodiments alternative cut characteristics such as crown percentage, crown angle, pavilion angle, and faceting or “cutting” style (brilliant, step, mixed, etc.) are contemplated.

Classic gemstone or diamond shapes include round brilliant, marquise, princess, radiant, emerald, pear, oval, and heart. The majority of diamonds sold are round brilliant cut having a round shape and 58 facets. Consequently, stone shapes other than round are categorized as “fancy” and tend to be slightly less expensive than round stones due to their popularity and the ratio of rough stone to finished stone weight. Diamond color is graded on an alphabetical scale from D to Z organized in groups. D, E, and F colored diamonds are rated “colorless” although virtually all diamonds have some tint of body color. Stones rated G through J are said to be “near colorless”, K through M rated stones are termed “faint yellow” and the remaining color ratings are “very light yellow” (N through R) and “light yellow” (S through Z). Additionally some diamonds are said to have “fancy” colors such as vivid and well-defined reds, blues, pinks, greens and bright yellows. These stones are usually rated according to their color and color intensity such as “fancy light blue” or “fancy vivid yellow” and are extremely rare and sought-after. Fluorescence or “photoluminescence” is the property of some diamonds to faintly glow a certain color (typically blue) when exposed to long-wave ultraviolet light. While fluorescence in colorless and some near colorless diamonds may impart a slightly bluish appearance and detract from the stone's value, strong, very strong, or medium blue fluorescence may slightly improve the color appearance of diamonds rated ‘H’ to ‘Z’ in color, potentially enhancing their value.

The clarity of a diamond is similarly rated on a scale which describes the degree to which a diamond is free of imperfections. Imperfections or “flaws” in a diamond include “blemishes” or exterior imperfections usually resulting from the cutting or polishing of the stone and “inclusions” which are tiny interior imperfections resulting from traces of minerals, gasses, or other elements trapped inside the diamond during the crystallization process. The established clarity scale includes F “flawless” or IF “internally flawless”, VVS1 or VVS2 “very, very slightly included”, VS1 or VS2 “very slightly included”, SI1, SI2, or SI3 “slightly included”, and I1, I2, or I3 “included” ratings. The gradations of each rating level are dependent on the number, size, noticeability and location of the inclusions present within the stone. The polish of diamond refers to the overall quality and uniformity of the polish performed on the diamond after cutting. Its grade is based on the final finish applied to the facets and facet junctures by a cutter or polisher and can vary between excellent, very good, good, fair, poor, or natural ratings. Symmetry by contrast, refers to the overall uniformity of the cut of a diamond and is based on the stone's proportions, the relation of one facet to another, and whether the stone has “out of round” or wavy girdles. A diamond's symmetry can be graded as excellent, very good, good, or fair. A diamond's weight is typically measured in carats (approximately 200 milligrams) or “points” with a point equaling 1/100^{th} of a carat.

Many diamond characteristic standards or rating systems were established by gemological labs which evaluate and certify the characteristics of a diamond, issuing a diamond grading report or certificate to the stone's owner. Such gemological labs include the Gemological Institute of America (GIA) Gem Trade Laboratory, the American Gem Society (AGS) Laboratories, the European Gemological Laboratory (EGL), or the International Gemological Institute (IGI). Although the certification of a diamond's characteristics by any well-known diamond lab will generally be accepted and such certification will generally increase the value of a stone due to the significant difference in price that can result from an independent jeweler or gemologist's grading error of one of a diamond's attributes; a lab's reputation in the industry, the number and type of diamond attributes it offers for certification, and the methodology it uses to certify each attribute can impact the value of a lab certification and consequently the diamond's price. For example, the GIA and AGS labs employ extremely rigorous testing by highly trained gemologist and offer diamond certification according to additional standards such as round stone cut grading (AGS Labs) and consequently diamond grading reports or certificates from these institutions have a greater potential to impact a diamond's sale price.

Also included in the transmitted product information are various cut characteristics which describe the cutting, proportioning, and precision of the faceting of a diamond and can include depth and table percentages, length-to-width ratios, girdle and culet descriptions, the stone's overall dimensions, etc. Depth and table percentages are terms used to express the ratio between various measurements of round diamonds. The depth percentage of a round diamond is calculated by dividing a diamond's depth measurement by the measurement of the stone's average diameter at the girdle and the table percentage is calculated by dividing the width of the table (the large, flat facet on top of a round diamond) by the average diameter of the diamond at the girdle. Cut characteristics such as depth and table percentages influence the brilliance and dispersion or “fire”, as well as the perceived size and to some degree, the apparent color of a diamond by impacting how light passes through it. A length-to-width ratio by comparison, is a metric of the cut or finish of non-round or “fancy” shaped diamonds. The ratio is calculated by dividing a stone's length by its width. Alternative cut characteristics including crown percentage, crown angle, pavilion angle, faceting or “cutting” style (brilliant, step, mixed, etc.) may also be provided or the present invention may be implemented utilizing only the physical dimensions or measurements of a stone transmitted as product information in alternative embodiments.

Although in the simplified illustration of FIG. 2 the various clients 204 and servers 202, 206 are shown directly connected to communications network 200, it will be appreciated by those having ordinary skill in the relevant art that they may be coupled to the network 200 in a variety of ways such as via a telephone network through a dial-up or a modem pool connection, via one or more other networks through a gateway, hub, router, or switch, or alternatively via a wireless connection. Similarly, although in the illustrated embodiment consumer client 204, vendor server 206, and retailer server 202 are each depicted as a conventional data processing system such as that illustrated in FIGS. 1a and 1b, it should likewise be appreciated by those of ordinary skill that alternative systems or devices may be utilized without departing from the spirit and scope of the present invention. For example, servers 202 and 206 may each comprise a “thin” or an “enterprise” server not necessarily having or being limited to all the features and devices of the data processing system illustrated in FIGS. 1 a and lb. Similarly, in alternative embodiments of the present invention, consumer client 204 may be implemented as a thin client device such as a network computer, palmtop computing device, or robust cellular or Personal Communications Services (PCS) telephone where such devices are currently being used with Internet micro-browsers. Although the clients and servers of these alternative embodiments may not necessarily include all of the devices and features of the above-described exemplary data processing system, the functionality of the present invention or a subset thereof may nevertheless be implemented with such devices.

Utilizing conventional data transmission techniques such as Simple Mail Transfer Protocol (SMTP), File Transfer Protocol (FTP), Hypertext Transfer Protocol (HTTP), or Data Space Transfer Protocol (DSTP), the various client 204 and server 202,206 systems or devices may transmit and receive data to and from one another across the communications network 200. For instance, in one embodiment of the present invention, vendor server 206 comprises an email or message server capable of retrieving and transmitting product information 208 from a storage device 212 coupled to it. It will be appreciated that the various storage devices of the illustrated system may include various mass store devices such as one or more DASD arrays, tape drives, optical drives, or other storage devices well known in the art. An email message is then transmitted from vendor server 206 to retailer server 202 containing retrieved product information 208 corresponding to products available from a vendor associated with vendor server 206. The received product information 208 is then processed within retailer server 202 according to the method of the present invention and subsequently stored within another storage device 212 coupled to retailer server 202. The processed and stored product information may then subsequently be retrieved and provided across communications network 200 to consumer client 204 as a displayed website or page.

In one embodiment of the present invention, consumer client 204 comprises a web browser client application such as Netscape™ Navigator™ formerly published by Netscape Corporation of Mountain View, Calif., the Internet Explorer™ published by Microsoft Corporation of Redmond, Wash., the user interface of America Online™, or the web browser client or markup language translator of any well-known supplier executing on a consumer data processing system. In this embodiment, retailer server 202 operates as a web server to provide the processed and stored product information using the Hypertext Transfer Protocol (HTTP) and the Standard Generalized (SGML), Extensible (XML), or Hypertext (HTML) markup language or Electronic Data Interchange (EDI) format across a communications network 200 encompassing the World Wide Web (WWW) portion of the Internet. In this manner, an electronic storefront web page or website including product data in graphical, textual, or even audio formats may be displayed to a consumer via a consumer client 204 browser. Conventional means exist by which a consumer client 204 may communicate with web server 202 to initiate requests for product data or web pages, indicate product selections for purchase, supply consumer information, etc. and by which server 202 may display web pages and return processed data to consumer client 204 via the World Wide Web 200.

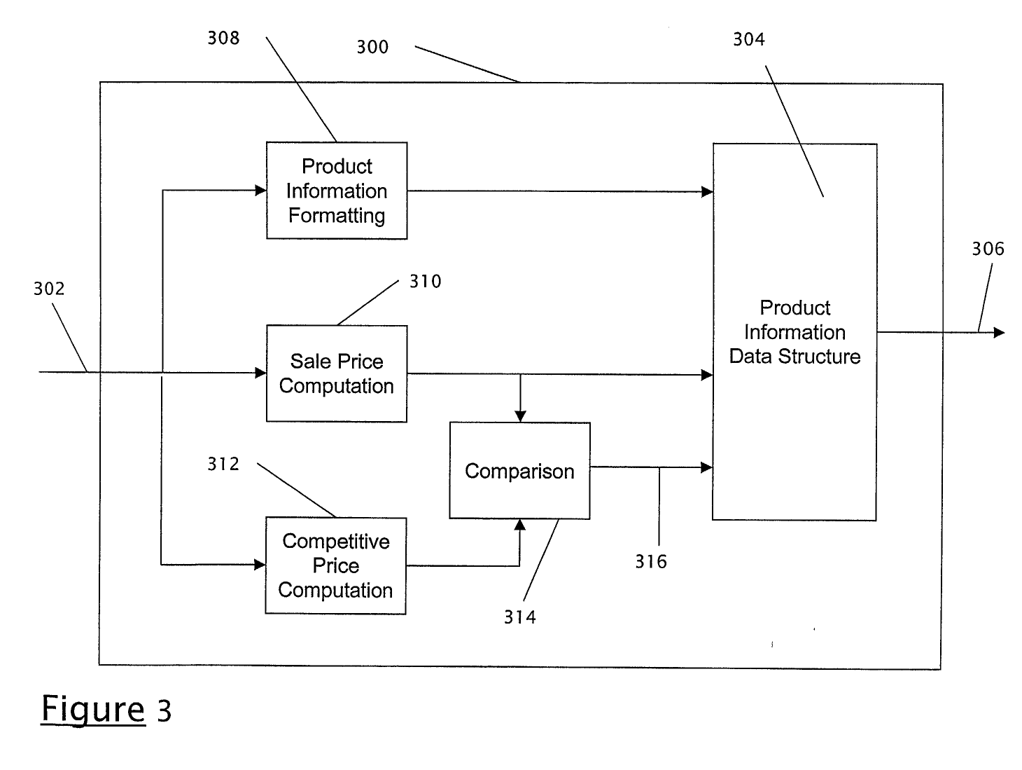

Referring now to FIG. 3, a high-level flow diagram of the operation of a server 300 such as retailer server 202 of FIG. 2 is illustrated. In the illustrated embodiment, server 300 includes an input 302 to receive vendor product information, such as the product information 208 described with reference to FIG. 2, for a product including one or more product attributes and a product cost. It will be appreciated by those having ordinary skill in the art that various inputs or input devices may be successfully employed with the present invention such as a network interface card or modem, a keyboard or cursor control device, a microphone coupled with speech recognition software, a scanner, or the like. Product information formatting 308 is performed on the received product attribute data and the product cost is similarly applied to facilitate a sales price computation 310 after each is received. Product formatting is performed to convert data from the various vendor formats in which it is received into a single form for presentation to a consumer client 204 using the method and system of the present invention.

A competitive price computation 312 is also carried out using the received product attribute(s) and thereafter a comparison 314 between the competitive and sales prices is performed. In one embodiment, one or more processors such as processor 120 of FIG. 1b are used to perform the product data formatting 308, the sale 310 and competitive 312 price computations, and the price comparison 314. In alternative embodiments however, specialized devices may be employed to provide the desired functionality. Subsequently, the appropriately formatted product characteristics and computed sales price are provided to and stored within a product information data structure associated with the particular product whose information has been received. In one embodiment, data structure 304 is a record of a structured query language (SQL) accessible database corresponding to a product capable of being offered for sale online and stored within system memory 126 of a retailer server data processing system. The data structure 304 may then be provided via an output 306 for storage within a mass store device such as storage device 210 for subsequent retrieval and transmission across a communications network to a consumer client web browser as described herein. In addition to the properly formatted product attributes and sales price, in the illustrated embodiment an indicator or flag 316 obtained from the comparison 314 of the calculated sales and competitive prices is provided to the product data structure 306 to indicate whether or not the product should be offered for sale on an associated electronic commerce store site. In alternative embodiments of the present invention other methods are employed such as using the comparison result to prevent product information or sale prices from being stored within a data structure or to modify other product data. For example, a sale price of zero could be substituted for products which are not to be offered for sale online. Similarly, in an alternative embodiment of the present invention, the described methods may be utilized by a vendor to determine a competitive price at which to offer products to retailers for resale. In such as system, a product attribute and a product cost indicative of either the production or acquisition cost of the vendor from another vendor further up the supply chain associated with a product may be used to determine a competitive price at which to offer products for sale to retailers (i.e. the retailer's “product cost”). The determined competitive “wholesale” price may then be compared to past prices or to the price of similar products in similar markets and the comparison may be utilized to determine whether to modify the computed price or to transmit the product attribute and computed price to one or more retailer for potential resale.

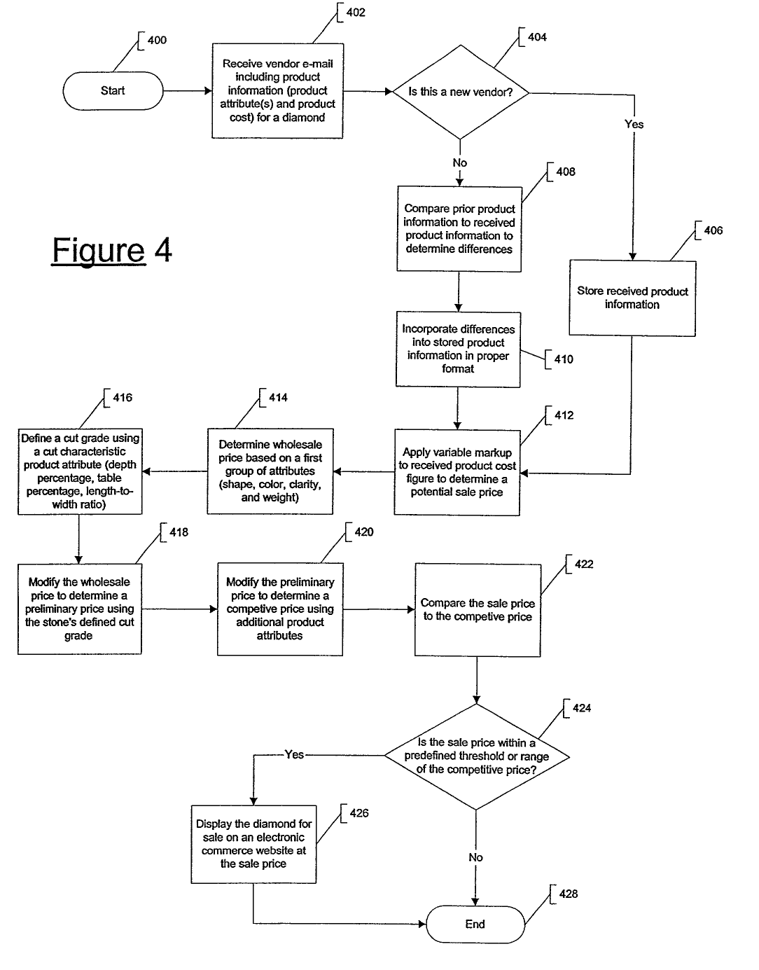

With reference now to FIG. 4, a high-level logic flowchart of one embodiment of the method of the present invention is illustrated. The process illustrated by FIG. 4 begins (block 400) and an email is then received from a product vendor containing product information for a diamond (block 402). As previously described, the received product information may contain a wide variety of data types including at least one product attribute or characteristic and a product cost which represents the vendor's asking price and the retailer's acquisition cost for the product. In the illustrated embodiment, a determination is then made whether the vendor has previously sent product information to the retailer (block 404) regarding products to be considered for sale. By making this determination, the depicted process enables a retailer to accept product data submissions and offer stones from an unlimited number of suppliers. This determination can be made simply by comparing an email address associated with the received email with a list or similar data structure of known vendor email addresses or a more complex system can be utilized such as creating unique vendor identifiers for each known vendor and requiring them to transmit them in the body of each email they send. For new vendors, the diamond's product information is extracted from the received email and stored for processing according to the method of the present invention (block 406). If it is determined that product data submissions have been received from the vendor before however, previously stored product information is compared to the new information (block 408) and updated based on identified differences between the two (block 410). New diamonds may be added, previously available ones may be removed due to sale or consignment by the vendor or a third party such as another retailer, additional characteristics may be provided, previously supplied attributes may be changed, and frequently, a diamond's cost may increase or decrease due to market conditions.

After the new product information has been stored (block 406) or updated (block 410) a sale price modification factor or “markup” is applied to the diamond's cost to determine a potential sale price (block 412). The amount of the markup is variable in one embodiment and dependent on the original cost. Diamonds falling within a lower range of vendor prices are assigned a higher markup while stones falling within a higher cost range are given a lower markup. In the illustrated embodiment, the received product attribute(s) include a first group of diamond properties or attributes which are used to determine a wholesale or base price (block 414). In one embodiment of the invention a wholesale pricing index such as the Rapaport Diamond Report™ is utilized to determine the diamond's wholesale or base price based upon its shape, size, color, and clarity rating. Also included within the received product attribute(s) in the depicted embodiment are one or more cut characteristics such as shape, depth percentage, pavilion depth, table percentage, table size, crown percentage, crown angle, pavilion angle, culet size, girdle thickness or condition, faceting style, and length-to-width ratio, etc. A cut grade is then defined for the diamond using one or more cut characteristics (block 416). Although it will be appreciated by those having ordinary skill that alternative cut characteristics and cut grades may be implemented within the teaching of the present invention, the following tables illustrate exemplary characteristics and grades for round brilliant (Table 1) and pear-shaped (Table 2) diamond embodiments.

TABLE 1

| | |
|---|---|
| Table % | Depth % |

| Round Brilliant | Low | High | Low | High |
|---|---|---|---|---|
| Ideal | 53 | 58 | 60.1 | 62.9 |
| Premium | 53 | 60 | 59.8 | 63.5 |
| Very Good | 52 | 61 | 58.0 | 63.9 |
| Good | 52 | 66 | 56.5 | 65.6 |
| Fair | 51 | 68 | 55.0 | 67.0 |
| Poor | <51 | >68 | <55 | >67 |

TABLE 2

| | | | | | Length-to- | |
|---|---|---|---|---|---|---|
| | Table % | | Depth % | | Width Ratio | |
| Pear | Low | High | Low | High | Low | High |
| Very Good | 52 | 67 | 58.0 | 63.9 | 1.5 | 1.75 |
| Good | 51 | 68 | 56.5 | 65.6 | 1.35 | 1.80 |
| Fair | 48 | 70 | 55.0b | 67.0 | 1.2 | 2.10 |
| Poor | <48 | >70 | <55 | >67 | 1.0 | NA |

Once a cut grade has been defined for a diamond using cut characteristic specifications such as those described in the tables above it can then be used to modify the previously calculated wholesale price to determine a preliminary competitive price (block 418). In one embodiment this is accomplished by increasing the wholesale price by a predefined percentage dependent on the stone's cut grade. This preliminary price may be used as the competitive price for comparison purposes, however, in the illustrated embodiment this preliminary price is further modified using additional characteristics or attributes of the diamond (block 420) such as fluorescence, polish, symmetry, and lab certification in order to provide a more precise competitive price determination. The amount of this competitive price modification factor is dependent both on the characteristic (e.g. fluorescence) and the quality of the stone represented by some combination of its carat weight, color and clarity rating. The sale and competitive prices are then compared (block 422) to determine whether the calculated sale price is within a predefined range or threshold of the competitive price (block 424).

A diamond having a sale price within the predefined range or threshold is deemed to have a “fair” price and is accordingly displayed for sale on an electronic commerce website at the previously determined sale price (block 426) before the described process concludes (block 428). If the sale price fails to meet this threshold, the process terminates (block 428) and the diamond is not displayed for sale. In an alternative embodiment, additional criteria may be used for determining whether a diamond should be offered for sale online. For example, an e-commerce merchant may only wish to display stones having a minimum carat weight or clarity rating in order to exercise quality control over their site's inventory. Moreover, in an additional alternative embodiment of the present invention the method may be varied such that a diamond is offered at a competitive price determined as described herein if it is determined to provide a sufficient markup or profit above the diamond's cost.

Although specific attributes or characteristics have been previously described, in an alternative embodiment a product cost, a first attribute, and a second attribute are received where objective pricing information is available for the first attribute and is not for the second attribute. The second attribute's effect on product price is therefore subjective at least to some degree. For example, an automobile's make, model, and trim level would all be examples of product attributes for which objective pricing information is available such as the National Automobile Dealer's Association (NADA) or Kelley Blue Book™ pricing guide value. No objective pricing information would be directly available with respect to a car's color by comparison.

Using the proposed method embodiment, a potential sales price is determined by applying a markup to the received product cost, a competitive price is determined using the first and second attributes and then compared to the potential sales price. If the potential sales price is within a predefined threshold or range of the competitive price, the product is offered for sale on an electronic commerce website store page. To determine a competitive price, a base or wholesale price is first determined using the first attribute which is then modified to determine the competitive price using the second subjective attribute. To accomplish this, pricing information indicating what impact the second attribute's value or status should have on the base price must be determined. For example, if the paint color of a car were provided as the second attribute then sales figures of each possible color could be examined to determine consumer preference and a suitable price modifier could be determined or defined for the most popular color or for each car based on its relative popularity, etc.

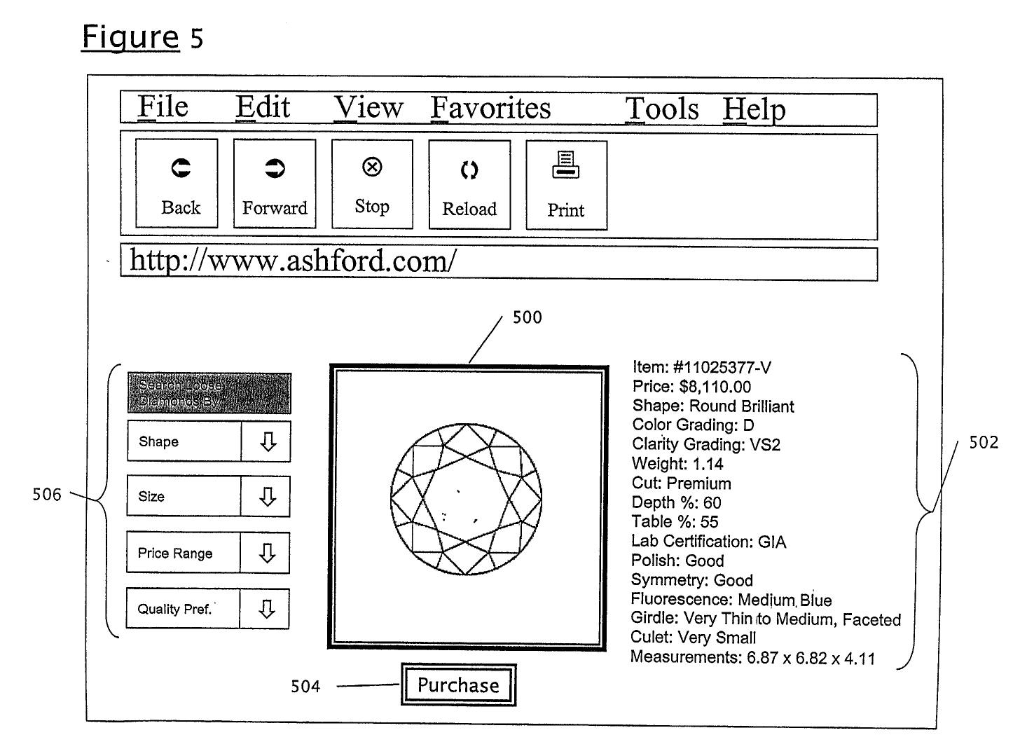

Referring now to FIG. 5, web browser display output of a consumer client according to one embodiment of the present invention is illustrated. Specifically, FIG. 5 illustrates the display of a product for sale according to the method of the present invention. Included within the depicted screenshot display is an image 500 of a diamond, such as a JPEG or GIF (Graphic Interchange Format) file well known in the art, offered for sale, various other formatted pieces of product information 502, a purchase selection element 504 allowing a consumer or other user to select the displayed product for purchase via the e-commerce site, and search tool elements 506 allowing such a user to find available products based on search criteria. Although in the illustrated embodiment the discussed product is a diamond it should be appreciated that various other products and consequently various product information and search criteria could be similarly displayed utilizing the method and system of the present invention.

Thus, an electronic commerce product pricing and selection system and method is disclosed. Although the present invention is described herein with reference to a specific preferred embodiment, many modifications and variations therein will readily occur to those with ordinary skill in the art. Accordingly, all such variations and modifications are included within the intended scope of the present invention as defined by the following claims.

What is claimed is:

1. A method comprising:
receiving a product attribute and a product cost corresponding to a product from a vendor via a communications network;
determining a sale price for said product utilizing said product cost;
determining a competitive price for said product utilizing said product attribute;
comparing said sale price to said competitive price; and
automatically displaying said product for sale on a website at said sale price in response to said comparison.

2. The method as set forth in claim 1, wherein determining a sale price for said product utilizing said product cost comprises applying a sale price modification factor to said product cost, wherein said sale price modification factor is selected based upon said product cost.

3. The method as set forth in claim 1, wherein said product comprises a gemstone and determining a competitive price for said product utilizing said product attribute comprises:
defining a cut grade for said gemstone in response to receiving said product attribute; and
determining a competitive price for said gemstone utilizing said cut grade.

4. The method as set forth in claim 3, wherein:
receiving said product attribute and said product cost corresponding to said product further comprises receiving a cut characteristic and a first plurality of product attributes including a shape, a color grading, a clarity grading, and a weight,
defining a cut grade for said gemstone in response to receiving said product attribute comprises defining a cut grade for said gemstone utilizing said cut characteristic, and
determining a competitive price for said product utilizing said product attribute further comprises:
determining a first price for said gemstone utilizing said first plurality of product attributes; and
determining a second price for said gemstone utilizing said first price and said cut grade.

5. The method as set forth in claim 4, wherein receiving a cut characteristic and a first plurality of product attributes including a shape, a color grading, a clarity grading, and a weight comprises receiving a cut characteristic selected from the group consisting of: a shape, a depth percentage, a pavilion depth, a table percentage, a table size, a crown percentage, a crown angle, a pavilion angle, a culet size, a girdle thickness, a faceting style, and a length-to-width ratio.

6. The method as set forth in claim 4, wherein:
receiving said product attribute and said product cost corresponding to said product further comprises receiving a second plurality of product attributes including a polish grading, a symmetry grading, a fluorescence grading, and a lab certification identifier, and
determining a competitive price for said product utilizing said product attribute further comprises determining a competitive price for said gemstone utilizing said second price and said second plurality of product attributes.

7. The method as set forth in claim 6, wherein determining a competitive price for said gemstone utilizing said second price and said second plurality of product attributes comprises:
defining a competitive price modification factor for one of said second plurality of product attributes utilizing said first plurality of product attributes; and
determining a competitive price for said gemstone utilizing said second price and said competitive price modification factor.

8. The method as set forth in claim 4, wherein said gemstone comprises a fancy cut diamond, said cut characteristic comprises a length-to-width ratio, and defining a cut grade for said gemstone utilizing said cut characteristic comprises defining a cut grade for said gemstone utilizing said length-to-width ratio.

9. The method as set forth in claim 1, wherein:
comparing said sale price to said competitive price comprises:
defining a range of price values utilizing said competitive price; and
determining whether said sale price is within said range of price values;
and further wherein automatically displaying said product for sale on a website at said sale price in response to said comparison comprises displaying said product for sale on said website in response to a determination that said sale price is within said range of price values.

10. The method as set forth in claim 1, wherein:
comparing said sale price to said competitive price comprises:
calculating a difference between said competitive price and said sale price;
and further wherein automatically displaying said product for sale on a website at said sale price in response to said comparison comprises:
comparing said difference between said competitive price and said sale price to a predefined threshold; and
displaying said product for sale on said website in response to a determination that said difference is less than or equal to said predefined threshold.

11. The method as set forth in claim 1, wherein:
comparing said sale price to said competitive price comprises:
calculating a ratio of said sale price to said competitive price;
and further wherein automatically displaying said product for sale on a website at said sale price in response to said comparison comprises:
comparing said ratio of said sale price to said competitive price to a predefined threshold; and
displaying said product for sale on said website in response to a determination that said difference is less than or equal to said predefined threshold.

12. A machine-readable medium having a plurality of machine-executable instructions embodied therein which when executed by a machine, cause said machine to perform a method comprising:
receiving a product attribute and a product cost corresponding to a product from a vendor via a communications network;
determining a sale price for said product utilizing said product cost;
determining a competitive price for said product utilizing said product attribute;
comparing said sale price to said competitive price; and
automatically displaying said product for sale on a website at said sale price in response to said comparison.

13. The machine-readable medium as set forth in claim 12, wherein determining a sale price for said product utilizing said product cost comprises applying a sale price modification factor to said product cost, wherein said sale price modification factor is selected based upon said product cost.

14. The machine-readable medium as set forth in claim 12, wherein said product comprises a gemstone and determining a competitive price for said product utilizing said product attribute comprises:
defining a cut grade for said gemstone in response to receiving said product attribute; and
determining a competitive price for said gemstone utilizing said cut grade.

15. The machine-readable medium as set forth in claim 14, wherein:
receiving said product attribute and said product cost corresponding to said product further comprises receiving a cut characteristic and a first plurality of product attributes including a shape, a color grading, a clarity grading, and a weight,
defining a cut grade for said gemstone in response to receiving said product attribute comprises defining a cut grade for said gemstone utilizing said cut characteristic, and
determining a competitive price for said product utilizing said product attribute further comprises:
determining a first price for said gemstone utilizing said first plurality of product attributes; and
determining a second price for said gemstone utilizing said first price and said cut grade.

16. The machine-readable medium as set forth in claim 15, wherein receiving a cut characteristic and a first plurality of product attributes including a shape, a color grading, a clarity grading, and a weight comprises receiving a cut characteristic selected from the group consisting of: a shape, a depth percentage, a pavilion depth, a table percentage, a table size, a crown percentage, a crown angle, a pavilion angle, a culet size, a girdle thickness, a faceting style, and a length-to-width ratio.

17. The machine-readable medium as set forth in claim 15, wherein:
receiving said product attribute and said product cost corresponding to said product further comprises receiving a second plurality of product attributes including a polish grading, a symmetry grading, a fluorescence grading, and a lab certification identifier, and
determining a competitive price for said product utilizing said product attribute further comprises determining a competitive price for said gemstone utilizing said second price and said second plurality of product attributes.

18. The machine-readable medium as set forth in claim 17, wherein determining a competitive price for said gemstone utilizing said second price and said second plurality of product attributes comprises:
defining a competitive price modification factor for one of said second plurality of product attributes utilizing said first plurality of product attributes; and
determining a competitive price for said gemstone utilizing said second price and said competitive price modification factor.

19. The machine-readable medium as set forth in claim 15, wherein said gemstone comprises a fancy cut diamond, said cut characteristic comprises a length-to-width ratio, and defining a cut grade for said gemstone utilizing said cut characteristic comprises defining a cut grade for said gemstone utilizing said length-to-width ratio.

20. The machine-readable medium as set forth in claim 12, wherein:
comparing said sale price to said competitive price comprises:
defining a range of price values utilizing said competitive price; and
determining whether said sale price is within said range of price values;
and further wherein automatically displaying said product for sale on a website at said sale price in response to said comparison comprises displaying said product for sale on said website in response to a determination that said sale price is within said range of price values.

21. The machine-readable medium as set forth in claim 12, wherein:
comparing said sale price to said competitive price comprises:
calculating a difference between said competitive price and said sale price;
and further wherein automatically displaying said product for sale on a website at said sale price in response to said comparison comprises:
comparing said difference between said competitive price and said sale price to a predefined threshold; and
displaying said product for sale on said website in response to a determination that said difference is less than or equal to said predefined threshold.

22. The machine-readable medium as set forth in claim 12, wherein:
comparing said sale price to said competitive price comprises:
calculating a ratio of said sale price to said competitive price;
and further wherein automatically displaying said product for sale on a website at said sale price in response to said comparison comprises:
comparing said ratio of said sale price to said competitive price to a predefined threshold; and
displaying said product for sale on said website in response to a determination that said difference is less than or equal to said predefined threshold.

23. A data processing system comprising:
a storage device to receive a product attribute and a product cost corresponding to a product from a vendor via a communications network;
a processor to determine a sale price for said product utilizing said product cost and a competitive price for said product utilizing said product attribute and to compare said sale price to said competitive price; and
a display device to automatically display said product for sale on a website at said sale price in response to said comparison.

24. The data processing system as set forth in claim 23, wherein said product comprises a gemstone and said processor to determine a competitive price for said product utilizing said product attribute comprises a processor to define a cut grade for said gemstone utilizing said product attribute, and to determine a competitive price for said product utilizing said cut grade.

25. The data processing system as set forth in claim 24, wherein:
said storage device to receive a product attribute and a product cost corresponding to a product from a vendor via a communications network comprises a storage device to receive a cut characteristic and a first plurality of product attributes including a shape, a color grading, a clarity grading, and a weight;
said processor to define a cut grade for said gemstone utilizing said product attribute comprises a processor to define a cut grade for said gemstone utilizing said cut characteristic; and
said processor to determine a competitive price for said product utilizing said product attribute further comprises a processor to determine a first price for said gemstone utilizing said first plurality of product attributes and to determine a second price for said gemstone utilizing said first price and said cut grade.

26. The data processing system as set forth in claim 25, wherein said gemstone comprises a fancy cut diamond, said cut characteristic comprises a length-to-width ratio, and said processor to define a cut grade for said gemstone utilizing said cut characteristic comprises a processor to define a cut grade for said gemstone utilizing said length-to-width ratio.
